(19) United States
(12) Patent Application Publication
(10) Pub. No.: US 2023/0118323 A1
(43) Pub. Date: Apr. 20, 2023

(54) MACHINE LEARNING VALIDATION AND ACCURACY

(71) Applicant: Meta Platforms, Inc., Menlo Park, CA (US)

(72) Inventors: Hagay Lupesko, Redwood City, CA (US); Chuan Jiang, Canonsburg, PA (US); Andrey Malevich, San Francisco, CA (US); Oren Sar Shalom, Nes Ziona (IL)

(21) Appl. No.: 17/969,599

(22) Filed: Oct. 19, 2022

Related U.S. Application Data
(60) Provisional application No. 63/257,439, filed on Oct. 19, 2021.
(60) Provisional application No. 63/328,870, filed on Apr. 8, 2022.

(51) Int. Cl. G06N 20/00

(52) U.S. Cl. CPC G06N 20/00

(57) ABSTRACT

In one embodiment, one or more computing systems may determine a first set of bins that collectively cover a pre-determined numerical range with each bin covering a sub-range of the pre-determined range. The system may determine a second set of bins that collectively cover the pre-determined range with each covers a different but overlapping sub-range with respect to a corresponding bin in the first bin set. The system may access a value that falls within the pre-determined range. The system may determine that the value falls within a first bin of the first bin set and a second bin of the second bin set. The system may determine a positive value for each the first and second bins. The positive values indicate an association level of the value with the first and second bins. The system may determine a representation of the value based on the positive values.

### PRIORITY

This application claims the benefit under 35 U.S.C. § 119(e) of U.S. Provisional Patent Application No. 63/257439, filed 19 Oct. 2021, and U.S. Provisional Patent Application No. 63/328870, filed 8 Apr. 2022, which are incorporated herein by reference.

### BRIEF DESCRIPTION OF THE DRAWINGS

FIG. 1 illustrates an example logical architecture of a computing device 1100 for validating a machine-learning model training.

FIG. 2 illustrates an example method for validating a machine-learning model training.

FIG. 3 illustrates two example sets of overlapping bins with log-scale and K=2.

FIG. 4 illustrates three example sets of overlapping bins with log-scale and K=3.

FIG. 5 illustrates two example sets of bins with linear-scale and K=2.

FIG. 6 illustrates three example sets of bins with linear-scale and K=3.

FIG. 7 illustrates an example method of determining a representation of a feature value based on soft assignments of overlapping bins.

FIG. 8 illustrates an example network environment associated with a social-networking system

FIG. 9 illustrates example social graph.

FIG. 10 illustrates an example computer system.

### DESCRIPTION OF EXAMPLE EMBODIMENTS

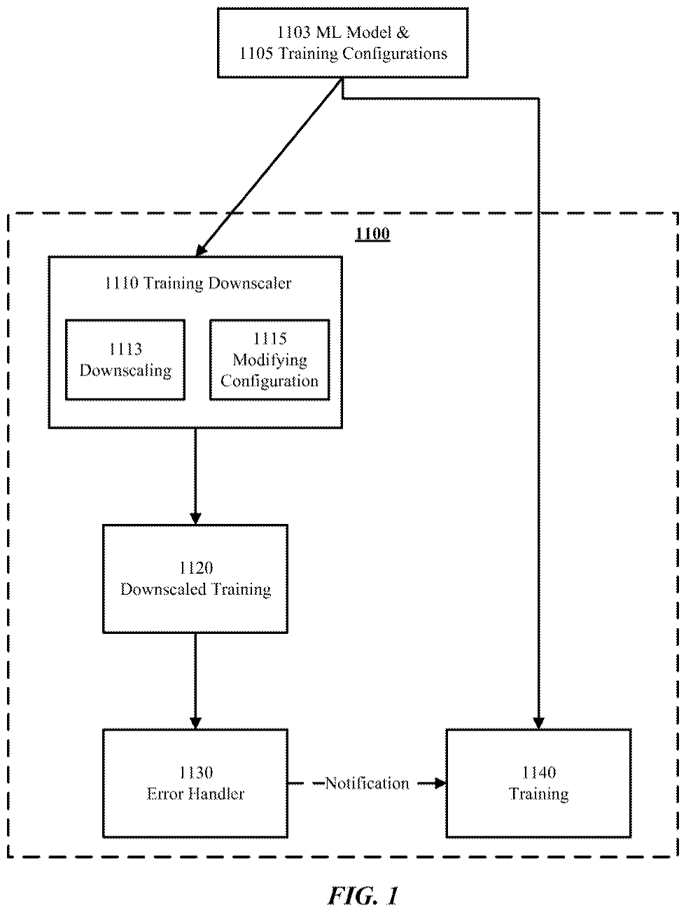

FIG. 1 illustrates an example logical architecture of a computing device 1100 for validating a machine-learning model training. In particular embodiments, a machine-learning model 1103 may be defined to be trained. The machine-learning model 1103 may comprise a large number of internal parameters to be trained. The machine-learning model 1103 may utilize one or more feature embedding tables. Each of the one or more feature embedding tables may comprise a large number of items. An item in one of the one or more feature embedding tables may be represented in a large dimensional embedding space. Although this disclosure describes a particular machine-learning model for training, this disclosure contemplates any suitable machine-learning model for training.

In particular embodiments, training configurations 1105 associated with the machine-learning model 1103 may also be prepared. The training configurations 1105 may comprise a large training dataset covering a variety of samples. The training configuration 1105 may require a large number of training iterations either based on stringent training completion conditions or based on an explicitly specified number of iterations. The training configurations 1105 may also comprise configurations associated with evaluation, publishing, and regular storing internal parameters in terms of checkpoints. Although this disclosure describes particular machine-learning model training configurations, this disclosure contemplates any suitable machine-learning model training configurations.

In particular embodiments, the computing device 1100 may access a definition of a machine-learning model 1103 and its corresponding training configurations 1105. The computing device 1100 may adjust the definition of the machine-learning model 1103 to downscale the machine-learning model 1103. The computing device 1100 may modify one or more of the corresponding training configurations 1105 to reduce complexity of training the machine-learning model 1103. The computing device 1100 may perform a training of the machine-learning model of the adjusted definition using the modified corresponding training configurations. The computing device 1100 may determine that one or more errors caused by either the non-adjusted definition of the machine-learning model or non-modified corresponding training configurations occur based on a return code of the downscaled training. The computing device 1100 may cause a training of the machine-learning model 1103 of non-adjusted definition using the non-modified corresponding training configurations 1105 to be aborted in response to the determination. Although this disclosure describes validating a machine-learning training in a particular manner, this disclosure contemplates validating a machine-learning training in any suitable manner.

In particular embodiments, a training downscaler 1110 may downscale the machine-learning model 1103 and modify the training configurations 1105 to perform a downscaled training. The downscaled training may be performed to validate the model training in a relatively small amount of time using a relatively small amount of resources.

In particular embodiments, a downscaling unit 1113 within the training downscaler 1110 may reduce a number of neurons in each hidden layer of the machine-learning model 1103. As an example and not by way of limitation, the machine-learning model 1103 may comprise a Dense layer with 1024 neurons. The downscaling unit 1113 may reduce the number of the neurons within the Dense layer from 1024 to 128. The downscaling unit 1113 may also reduce the neurons of the other hidden layers within the machine-learning model 1103. Although this disclosure describes reducing a number of neurons within a machine-learning model in a particular manner, this disclosure contemplates reducing a number of neurons within a machine-learning model in any suitable manner.

In particular embodiments, the downscaling unit 1113 may identify oversized embedding tables that are utilized by the machine-learning model 1103. The downscaling unit 1113 may determine that a binary large object (blob) is an embedding table if the blob is taken by an embedding table lookup operator as an input embedding table. The downscaling unit 1113 may determine that the embedding table is oversized if the size of the embedding table is larger than a pre-determined threshold. Although this disclosure describes identifying oversized embedding tables in a particular manner, this disclosure contemplates identifying oversized embedding tables in any suitable manner.

In particular embodiments, the downscaling unit 1113 may reduce sizes of the identified oversized embedding tables. The downscaling unit 1113 may reduce a number of features mapped to an embedding vector by an oversized embedding table. As an example and not by way of limitation, an oversized embedding table may map 2 million features into an embedding space of 12048 dimensions. The downscaling unit 1113 may reduce the number of features in the oversized embedding table into 1100 thousand features from 2 million features. When an embedding table lookup operator is called for a feature, the feature goes through a hash operator such that the feature is hashed into an index within [1,100,000], not in [1,2,000,000]. The hashed index will be provided to the embedding table lookup operator. Although this disclosure describes reducing a number of features in an oversized embedding table in a particular manner, this disclosure contemplates reducing a number of features in an oversized embedding table in any suitable manner.

In particular embodiments, the downscaling unit 1113 may also reduce a number of dimensions for the oversized embedding table. As an example and not by way of limitation, continuing with a prior example, the oversized embedding table maps a feature into an embedding vector in 12048 dimensions. The downscaling unit 1113 may reduce the number of dimensions from 12048 into 1256 by performing a dimension reduction algorithm. Although this disclosure describes reducing a number of dimensions of an oversized embedding table in a particular manner, this disclosure contemplates reducing a number of dimensions of an oversized embedding table in any suitable manner.

In particular embodiments, a modifying configuration unit 1115 of the training downscaler 1110 may modify one or more training configurations 1105 associated with the machine-learning model 1103 to reduce complexity and required time for the downscaled training. The modifying configuration unit 1115 may disable a distributed training option so that the training can be run on a single machine. The modifying configuration unit 1115 may reduce the size of the training data. As an example and not by way of limitation, a machine-learning training may be configured to run on a cluster of computing devices in a data center. The size of the training data may be 50 Gb. The modifying configuration unit 1115 may change the configuration so that the training can be run on a single host. Running the training on a single host may be feasible after reducing the size and dimension of the oversized embedding tables. The modifying configuration unit 1115 may also reduce the size of the training data to 1100 Mb by randomly selecting the training data from the 50 Gb training dataset. Although this disclosure describes modifying training configurations to reduce complexity and required time for the downscaled training in a particular manner, this disclosure contemplates modifying training configurations to reduce complexity and required time for the downscaled training in any suitable manner.

In particular embodiments, the modifying configuration unit 1115 may further modify the one or more training configurations 1105 associated with the machine-learning model 1103. The modifying configuration unit 1115 may disable checkpoint such that the training parameters are not regularly stored. The modifying configuration unit 1115 may disable model publishing. The modifying configuration unit 1115 may skip evaluation phase after training phase. The modifying configuration unit 1115 may also disable recurring training. Therefore, the training may run only for only once with the prepared reduced training data set. Although this disclosure describes modifying training configurations further to reduce complexity and required time for the downscaled training in a particular manner, this disclosure contemplates modifying training configurations further to reduce complexity and required time for the downscaled training in any suitable manner.

In particular embodiments, a downscaled training module 1120 may run a downscaled training with the downscaled version of the machine-learning model 1103 and the modified set of training configurations 1105. Typically, the downscaled training may complete within a number of minutes rather than a number of hours or even a number of days thanks to the downscaled model and modified training configurations. Although this disclosure describes running a downscaled training in a particular manner, this disclosure contemplates running a downscaled training in any suitable manner.

In particular embodiments, the non-downscaled training module 1140 may run a training of the machine-learning model 1103 with the training configurations 1105. The non-downscaled training module 1140 may start the training in parallel with the training downscaler 1110, the downscaled training 1120, and the error handler module 1130. The training may run for a considerable amount of time on a cluster of computing devices.

In particular embodiments, an error handler module 1130 may analyze a result of the downscaled training performed by the downscaled training module 1120 based on a return code of the downscaled training. In particular embodiments, the return code may indicate that no error occurs during the downscaled training. In such a case, the error handler module 1130 may notify a non-downscaled training module 1140. The notification may indicate no signal demonstrating that the machine-learning model 1103 and its corresponding training configurations 1105 are error-prone. The non-downscaled training module 1140 may start or continue the training. In particular embodiments, the return code may indicate that one or more errors occurs during the downscaled training. If the error handler module 1130 determines that the one or more errors were caused by downscaling process performed by the training downscaler 1110, the error handler module 1130 may send a notification to the non-downscaled training module 1140. The notification may indicate no signal demonstrating that the machine-learning model 1103 and its corresponding training configurations 1105 are not error-prone. The non-downscaled training module 1140 may start or continue the training. In particular embodiments, the return code may indicate that one or more errors occurs during the downscaled training. If the error handler module 1130 determines that the one or more errors were caused by either the definition of the machine-learning model 1103 or the training configurations 1105 associated with the machine-learning model 1103, the error handler module 1130 may send a notification to the non-downscaled training module 1140. The notification may comprise the return code and indicate that the machine-learning model 1103 or its corresponding training configurations 1105 are error-prone. The non-downscaled training module 1140 may abort the training of the machine-learning model 1103 upon receiving the notification from the error handler module 1130 and return the return code received from the error handling module 1130. Although this disclosure describes aborting the non-downscaled training if an error caused by the machine-learning model or its corresponding training configurations occurs during the downscaled training in a particular manner, this disclosure contemplates aborting the non-downscaled training if an error caused by the machine-learning model or its corresponding training configurations occurs during the downscaled training in any suitable manner.

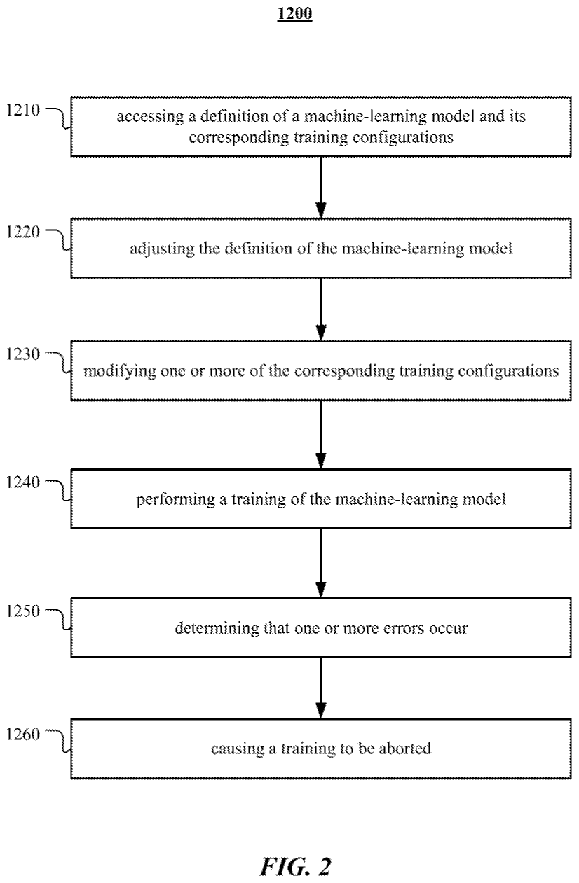

FIG. 2 illustrates an example method 1200 for validating a machine-learning model training. The method may begin at step 1210, where a computing device may access a definition of a machine-learning model and its corresponding training configurations. At step 1220, the computing device may adjust the definition of the machine-learning model to downscale the machine-learning model. At step 1230, the computing device may modify one or more of the corresponding training configurations to reduce complexity of training the machine-learning model. At step 1240, the computing device may perform a training of the machine-learning model of the adjusted definition using the modified corresponding training configurations. At step 1250, the computing device may determine that one or more errors caused by either the non-adjusted definition of the machine-learning model or non-modified corresponding training configurations occur based on a return code of the downscaled training. At step 1260, the computing device may cause a training of the machine-learning model of non-adjusted definition using the non-modified corresponding training configurations to be aborted in response to the determination. Particular embodiments may repeat one or more steps of the method of FIG. 2, where appropriate. Although this disclosure describes and illustrates particular steps of the method of FIG. 2 as occurring in a particular order, this disclosure contemplates any suitable steps of the method of FIG. 2 occurring in any suitable order. Moreover, although this disclosure describes and illustrates an example method for validating a machine-learning model training including the particular steps of the method of FIG. 2, this disclosure contemplates any suitable method for validating a machine-learning model training including any suitable steps, which may include all, some, or none of the steps of the method of FIG. 2, where appropriate. Furthermore, although this disclosure describes and illustrates particular components, devices, or systems carrying out particular steps of the method of FIG. 2, this disclosure contemplates any suitable combination of any suitable components, devices, or systems carrying out any suitable steps of the method of FIG. 2.

Data binning, which is also called discrete binning or bucketing, is a data pre-processing technique that may be used in neural networks. The original data values which fall into a given small a bin range, may be replaced by a value representative of that bin range (e.g., the central value), as a form of quantization. Statistical data binning may be used as a way to group numbers of more or less continuous values into a smaller number of “bins”. For example, for data about a group of objects, the data may be arranged based on their characterization into a smaller number of bins (for example, grouping by price). It may also be used in multivariate statistics, binning in several dimensions at once.

Deep learning methods may incorporate multi-modal features. This may be done by, for example, concatenating the various modalities and passing them through stacked fully connected layers. The problem is how to incorporate numerical features. For example, the “price” may be used as a numerical feature on social network platform. The numerical feature may get values in the range of $1-10K. Therefore, incorporating that feature as-is might cause ill-condition, which normalization can't solve. In particular embodiment, a binning approach can be used to address this problem. For example, the range of values may be divided into a number of non-overlapping bins, e.g., 0-1, 1-2, 2-4, 4-8, etc. Then the numeric feature may go through a discretization process by replacing a value with the ID of the bin that the value falls into. From this point the network may learn a vector (distributed representation) for each bin and may represent the numeric feature by the vector of the associated bin.

However, the currently existing binning approaches may also have some problems. For example, items with similar values might belong to different bins. For instance, the values 7.9 and 8.1 may fall into different bins, although they are close, if the bin is divided on the number of 8. Furthermore, the binning approach may miss delicate differences within bins. For instance, most basketball shoes of a certain brand cost up to $100 and therefore they may fall into the same bin. However, there could be a big difference between a $90 pair of shoes and $110. Setting larger bins may mitigates the former problem, but could suffer more from the latter, and vice versa. Incorporating wide-ranged numerical features could be a ubiquitous problem in deep learning and it's worthwhile to address it.

To overcome the above problems, in particular embodiments, the system may create and use overlapping bins including K set of bins that have overlapping numerical ranges, such that each value may belong to exactly K bins. Then, the system may apply soft assignment (e.g., each of the K bins may get a positive value, such that they all sum up to 1) and the final representation of the value may be the weighted average of the associated vectors. In order to create the overlapping bins, the system may first create an initial or original set of non-overlapping bins (by e.g., log-scale or linear scale). Then each additional set of bins may be created by an offset of 1/K (e.g., K=2, 3, 4, etc.). As an example and not by way of limitation, in particular embodiments, the system may use K=2 to create two sets of overlapping bins. Assuming that the original set of bins is: 0-1, 1-2, 2-4, 4-8, the additional set of bins may be: 0.5-1.5, 1.5-3, 3-6. For a value of 2.5, which belongs to bins 2-4 and 1.5-3. The weight of each bin may be the closeness from its bin center. In the example here, the centers of the bins may be 3 and 2.25. Therefore, the distances will be abs(3-2.5)/2=0.25 and abs(2.25-2.5)/1.5=0.17. Hence, the unnormalized weights are 1/0.25=4 and 1/0.17=6 and the normalized weights may be: 0.40 (i.e., 4/(4+6)) for the 2-4 bin and 0.60 (i.e., 6/(4+6)) for the 1.5-3 bin. In particular embodiments, the system may use another weighting method that fits the data into some distributions, e.g., power-law distribution. As a result, using the multiple sets of overlapping bins, items with similar values may depart at most by a single bin and the rest of their bins may be identical as the final representation. Relatively distant values may have at most a single common bin. Furthermore, the values that are relatively distant from each other may reside in the edge of that bin and therefore their weights may be lower, which reduces its effect on the final representation.

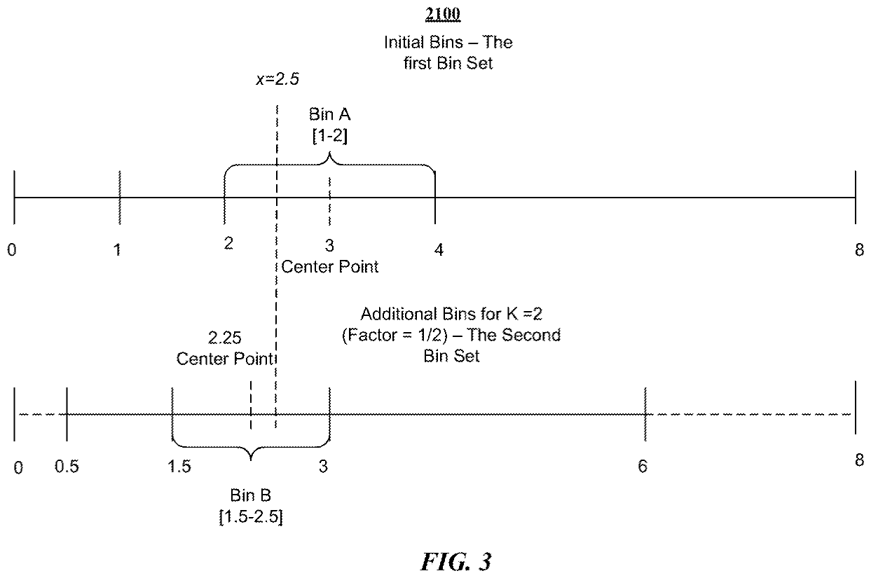

FIG. 3 illustrates two example sets of overlapping bins 2100 with log-scale and K=2. As an example and not by way of limitation, the initial set of bins may include a number of bin ranges in log-scale: 0-1, 1-2, 2-4, 4-8, . . . , etc. The end value of each bin may be an exponent of 2 (e.g., 1=2⁰, 2=2¹, 4=2², 8=2³, . . . , etc.). For K=2, the bin design may include two set of bins: the original set of bins and the additional set of bins. To determine the additional set of bins, the system may first divide the bin ranges of the original set by K=2 and then, determine the corresponding bin ranges based on the division result value. For example, for the bin range of 0-1, the system may divide the range of 0-1 by K=2, which results in 0.5. For the bin range of 1-2, the system may divide the range of 1-2 by K=2, which results in 0.5. As such, the first bin in the additional bin set may be 0.5-1.5, where the end of the bin range 1.5 may be determined by adding the start value 1 of the bin range 1-2 and the division result of 0.5 (the range 1-2 divided by K=2). Similarly, for the bin range of 2-4, the system may divide the range of 2-4 by 2 (which equals to 1), and then determine the end value of the corresponding additional bin range as 3 (adding 1 to the start value of the bin range 2-4). As such, the second additional bin range may be 1.5-3. Similarly, for the bin range of 4-8, the system may divide the range of 4-8 by 2 (which equals to 2), and then determine the end value of the corresponding additional bin range as 6 (adding 2 to the start value of the bin range 4-8). As such, the third additional bin range may be 3-6. The system may repeat this process to generate the additional set of bins including the bin ranges of 0.5-1.5, 1.5-3, 3-6, . . . , etc. In particular embodiments, the system may include a half bin range at the beginning of the additional bin set, e.g., 0-0.5 and 6-8 (when the 4-8 is the last bin in the initial set).

As a result, the additional bin set may cover the same numerical range with respect to the initial bin set, and the bin ranges of the two bin sets may have overlapping. For any particular feature value (e.g., an item price), the value may fall into two bin ranges including a first bin range in the initial bin set, and a second bin range in the additional bin set. As an example and not by way of limitation, for a value x=2.5, it may fall within the bin range of 2-3 of the initial bin set and at the same time fall within the bin range of 1.5-3 of the additional bin set. In particular embodiments, the system may use a soft assignment to determine the representation of the target feature value as represented by the ID of the bin(s) which the feature value fall within. In other words, each of the K bins may get a positive value, such that all the positive values may sum up to 1, and the final representation of the value may be the weighted average of the associated vectors. As an example, for the feature value of 2.5, which belongs to bins 2-4 of the initial bin set and 1.5-3 of the additional bin set. The weight of each bin may be either the closeness from its center. In the example here, the centers of the bins may be 3 and 2.25. Therefore, the distances will be abs(3-2.5)/2=0.25 and abs(2.25-2.5)/1.5=0.17. Hence, the unnormalized weights are 1/0.25=4 and 1/0.17=6 and the normalized weights may be: 0.40 (i.e., 4/(4+6)) for the 2-4 bin and 0.60 (i.e., 6/(4+6)) for the 1.5-3 bin. As such, the system may use the soft assignment to determine the representation of the target feature value as represented by the ID of the bin(s) which the feature value fall within. Each of the K bins may get a positive value and all the positive values will sum up to 1, and the final representation of the target feature value may be the weighted average of the associated vectors.

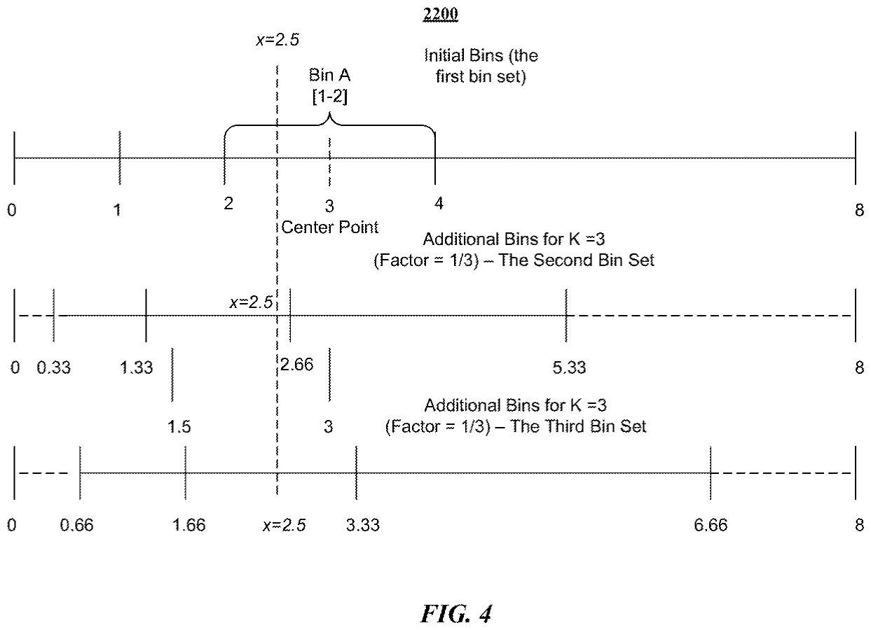

FIG. 4 illustrates three example sets of overlapping bins 2200 with log-scale and K=3. As an example and not by way of limitation, the initial set of bins may include a number of bin ranges in log-scale: 0-1, 1-2, 2-4, 4-8, . . . , etc. The end value of each bin may be an exponent of 2 (e.g., 1=2⁰, 2=2¹, 4=2², 8=2³, . . . , etc.). For K=3, the bin design may include three set of bins: the initial set of bins and two additional sets of bins. To determine the additional set of bins, the system may first divide the bin ranges of the original set by K=3 and then, determine the corresponding bin ranges based on the division result values. The beginning value of each bin range may be determined based on a factor of ⅓. For example, for the bin range of 0-1, the system may divide the range of 0-1 by K=3, which results in 0.33. For the bin range of 1-2, the system may divide the range of 1-2 by K=3, which results in 0.33. As such, the first bin in the additional bin set may be 0.33-1.33, where the end of the bin range 1.33 may be determined by adding the start value 1 of the bin range 1-2 and the division result of 0.33 (the range 1-2 divided by K=3). Similarly, for the bin range of 2-4, the system may divide the range of 2-4 by K=3, which results in 0.66, and then determine the end value of the corresponding additional bin range as 2.66 (adding 0.66 to the start value 2 of the bin range 2-4). As such, the second additional bin range may be 1.33-2.66. Similarly, for the bin range of 4-8, the system may divide the range of 4-8 by K=3, which results in 1.33, and then determine the end value of the corresponding additional bin range as 5.33 (adding 1.33 to the start value 4 of the bin range 4-8). As such, the third additional bin range may be 2.66-5.33. The system may repeat this process to generate the additional set of bins including the bin ranges of 0.33-1.33, 1.33-2.66, 2.66-5.33 . . . , etc. In particular embodiments, the system may include a half bin range at the beginning of the additional bin set, e.g., 0-0.33 to cover the beginning range of the 0-0.33. The additional bin set may also include a half bin rang at the end of bin set 5.33-8 to cover the end range of the bin set.

As a result, the additional bin set may cover the same numerical range with respect to the initial bin set, and the bin ranges of the two bin sets may have overlapping. For any particular feature value (e.g., an item price), the value may fall into two bin ranges including a first bin range in the initial bin set, and a second bin range in the additional bin set. As an example and not by way of limitation, for a value x=2.5, it may fall within the bin range of 2-3 of the initial bin set and at the same time fall within the bin range of 1.5-3 of the additional bin set. In particular embodiments, the system may use a soft assignment to determine the representation of the target feature value as represented by the ID of the bin(s) which the feature value fall within. In other words, each of the K bins may get a positive value, such that all the positive values may sum up to 1, and the final representation of the value may be the weighted average of the associated vectors. As an example, for the feature value of 2.5, which belongs to bins 2-4 of the initial bin set and 1.5-3 of the additional bin set. The weight of each bin may be either the closeness from its center. In this example, the centers of the bins may be 3 (for the bin 2-4) and 2.25 (for the bin 1.5-3). Therefore, the distances will be abs(3-2.5)/2=0.25 and abs(2.25-2.5)/1.5=0.17. Hence, the unnormalized weights are 1/0.25=4 and 1/0.17=6 and the normalized weights may be: 0.40 (i.e., 4/(4+6)) for the 2-4 bin and 0.60 (i.e., 6/(4+6)) for the 1.5-3 bin. As such, the system may use the soft assignment to determine the representation of the target feature value as represented by the ID of the bin(s) which the feature value fall within. Each of the K bins may get a positive value and all the positive values will sum up to 1, and the final representation of the target feature value may be the weighted average of the associated vectors.

To determine the second additional set of bins, the system may first divide the bin ranges of the original set by K=3 and then, determine the corresponding bin ranges based on the division result values. The beginning value of each bin range may be determined based on a factor of ⅔. For example, for the bin range of 0-1 and the factor of ⅔, the system may determine the beginning value of the first bin in this second set as 0.66 (i.e., (2-1)×⅔). For the bin range of 1-2, the system may determine the beginning value of the additional bin as 1.66 (i.e., 1+(2-1)×2/3).

As such, the first bin in the second additional bin set may be 0.66-1.66, where the end of the bin range 1.66 may be determined by adding the start value 1 of the bin range 1-2 and 0.66. Similarly, for the bin range of 2-4, the system may determine the beginning value as 3.33 (i.e., 2+(4-2)×⅔). As such, the second additional bin range may be 1.66-3.33. Similarly, for the bin range of 4-8, the system may determine the beginning value of this additional bin range as 6.66 (i.e., 4+(8-4)×⅔). As such, the third additional bin range may be 3.33-6.66. The system may repeat this process to generate the second additional set of bins including the bin ranges of 0.66-1.66, 1.66-3.33, 3.33-6.66 . . . , etc. In particular embodiments, the system may include a half bin range at the beginning of the additional bin set, e.g., 0-0.66 to cover the beginning range of the 0-0.66 and another half bin range at the end of the set 6.66-8 to cover the end range.

As a result, the two additional bin sets may cover the same numerical range with respect to the initial bin set, and the bin ranges of the three bin sets may have overlapping. For any particular feature value (e.g., an item price) within the range covered by the bin sets, the value may fall into three bin ranges including a first bin range in the initial bin set, a second bin range in the second bin set, and a third bin range in the third bin set. As an example and not by way of limitation, for a value x=2.5, it may fall within the bin range of 2-4 of the first bin set and at the same time fall within the bin range of 1.33-2.66 of the second bin set and the bin range of 1.66-3.33. In particular embodiments, the system may use a soft assignment to determine the representation of the target feature value as represented by the ID of the bin(s) which the feature value fall within. In other words, each of the K bins may get a positive value, such that all the positive values may sum up to 1, and the final representation of the value may be the weighted average of the associated vectors. The positive value may be determined based on the closeness to the center of the bin as divided by the length of the bin.

As an example, for the feature value of 2.5, which belongs to bins 2-4 of the first bin set, 1.33-2.66 of the second bin set, and 1.66-3.33 of the third bin set. The weight of each bin may be based on the closeness of the value from the bin center. In this example, the centers of the bins may be 3 (for the bin 2-4), 1.2995 (for the bin 1.33-2.66), 2.2495 (for the bin 1.66-3.33). Therefore, the distances may be abs(3-2.5)/2=0.25, abs(1.2995-2.5)/1.33=0.38, and abs(2.2495-2.5)/1.67=0.2003, respectively. Therefore, the unnormalized weights are the reciprocals of the weights. The normalized weights may be calculated by the relative weights of the unnormalized weight values. As such, the system may use the soft assignment to determine the representation of the target feature value as represented by the ID of the bin(s) which the feature value fall within. Each of the K bins may get a positive value and all the positive values will sum up to 1, and the final representation of the target feature value may be the weighted average of the associated vectors.

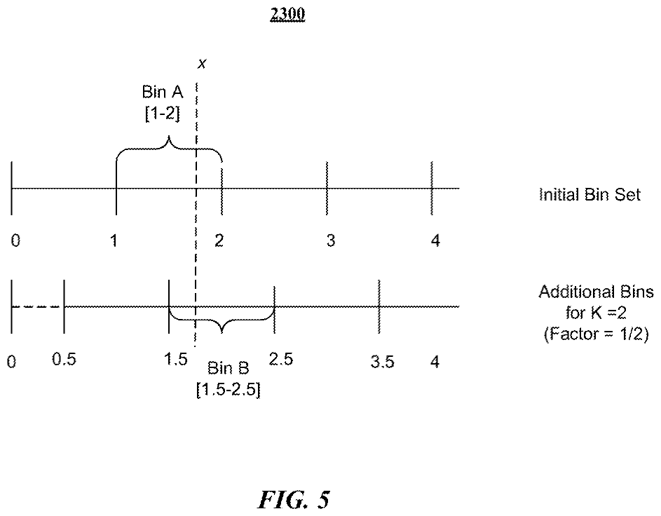

FIG. 5 illustrates two example sets of bins 2300 with linear-scale and K=2. Following the same principle and process and in the examples illustrated in FIG. 3, the system may determine two sets of bins with a linear scale. The first set of bins may include: 0-1, 1-2, 2-3, 3-4, . . . etc. The second set of bins may include 0.5-1.5, 1.5-2.5, 2.5-3.5, 3.5-4.5, . . . etc. The second set may also include a bin range of 0-0.5 to cover the beginning range of the set range. Each target feature value may fall within two bin ranges: one from the first bin set and one from the second bin set. The system may determine a positive value for each bin containing the target feature value based on the closeness to the center point (or closeness to one or two bin range ends) and determine the weight values of these bins. As such, the system may use the soft assignment to determine the representation of the target feature value as represented by the ID of the bin(s) which the feature value fall within. Each of the K bins may get a positive value and all the positive values will sum up to 1, and the final representation of the target feature value may be the weighted average of the associated vectors.

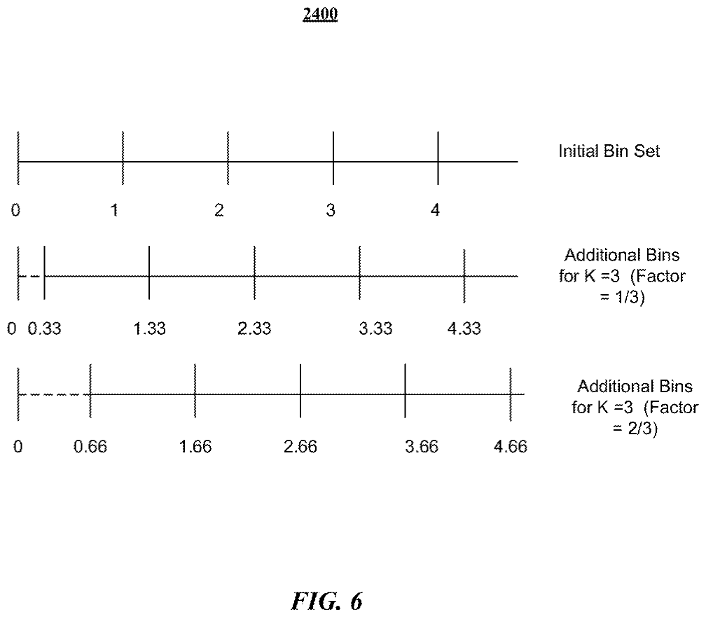

FIG. 6 illustrates three example sets of bins 2400 with linear-scale and K=3. Following the same principle and process and in the examples illustrated in FIG. 4, the system may determine three sets of bins with a linear scale. The first set of bins may include: 0-1, 1-2, 2-3, 3-4, . . . etc. The second set of bins may include 0.33-1.33, 1.33-2.33, 2.33-3.33, 3.33-4.33, . . . etc. The second set may also include a bin range of 0-0.33 to cover the beginning range of the set range. Each target feature value may fall within three bin ranges: one from the first bin set, one from the second bin set, and one from the third bin set. The system may determine a positive value for each bin containing the target feature value based on the closeness to the center point (or closeness to one or two bin range ends) and determine the weight values of these bins. As such, the system may use the soft assignment to determine the representation of the target feature value as represented by the ID of the bin(s) which the feature value fall within. Each of the K bins may get a positive value and all the positive values will sum up to 1, and the final representation of the target feature value may be the weighted average of the associated vectors.

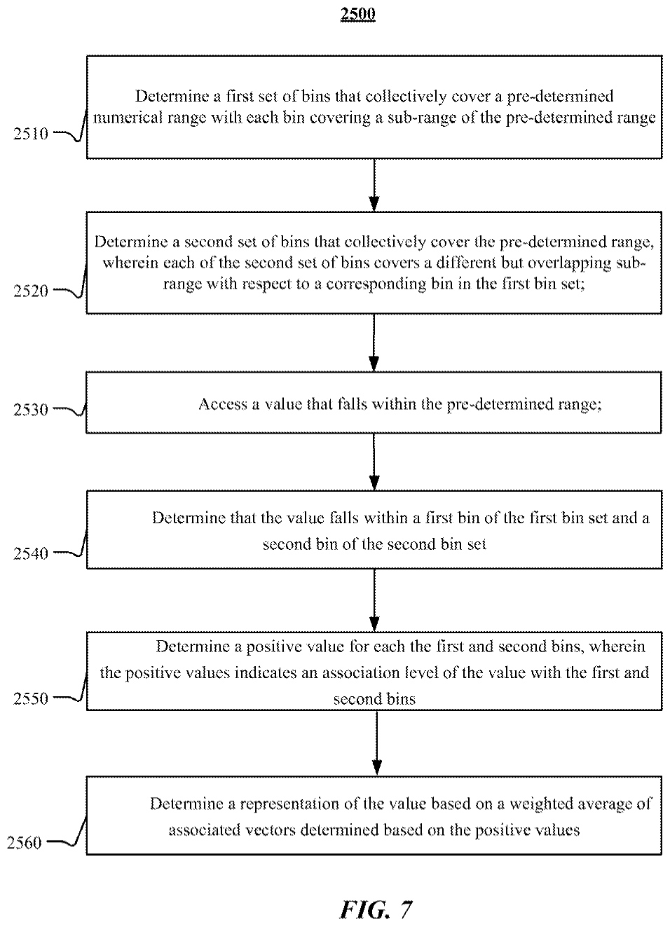

FIG. 7 illustrates an example method 2500 of determining a representation of a feature value based on soft assignments of overlapping bins. The method may begin at step 2510, where a computing system may determine a first set of bins including a number of bins. The first set of bins may collectively cover a pre-determined numerical range with each bin covering a sub-range of the pre-determined range. At step 2520, the system may determine a second set of bins which collectively cover the same pre-determined range with the first set of bins. The second set of bins each cover a different but overlapping sub-ranges with respect to the bins in the first bin set. For any value that falls within the pre-determined range, the value may fall within a bin of the first bin set and another bin of the second bin set. At step 2530, the system may access a value that falls within the pre-determined range. At step 2540, the system may determine that the value falls within a first bin on the first bin set and a second bin of a second bin set. At step 2550, the system may determine a positive value for the target feature value, indicating an association level with the bins of the first bin set and the second bin set, which the target feature value fall within. At step 2560, the system may determine a representation of the target feature value based on a weighted average of associated vectors as determined based on the positive values.

Particular embodiments may repeat one or more steps of the method of FIG. 7, where appropriate. Although this disclosure describes and illustrates particular steps of the method of FIG. 7 as occurring in a particular order, this disclosure contemplates any suitable steps of the method of FIG. 7 occurring in any suitable order. Moreover, although this disclosure describes and illustrates an example method for determining a representation of a feature value based on soft assignments of overlapping bins including the particular steps of the method of FIG. 7, this disclosure contemplates any suitable method for determining a representation of a feature value based on soft assignments of overlapping bins including any suitable steps, which may include all, some, or none of the steps of the method of FIG. 7, where appropriate. Furthermore, although this disclosure describes and illustrates particular components, devices, or systems carrying out particular steps of the method of FIG. 7, this disclosure contemplates any suitable combination of any suitable components, devices, or systems carrying out any suitable steps of the method of FIG. 7.

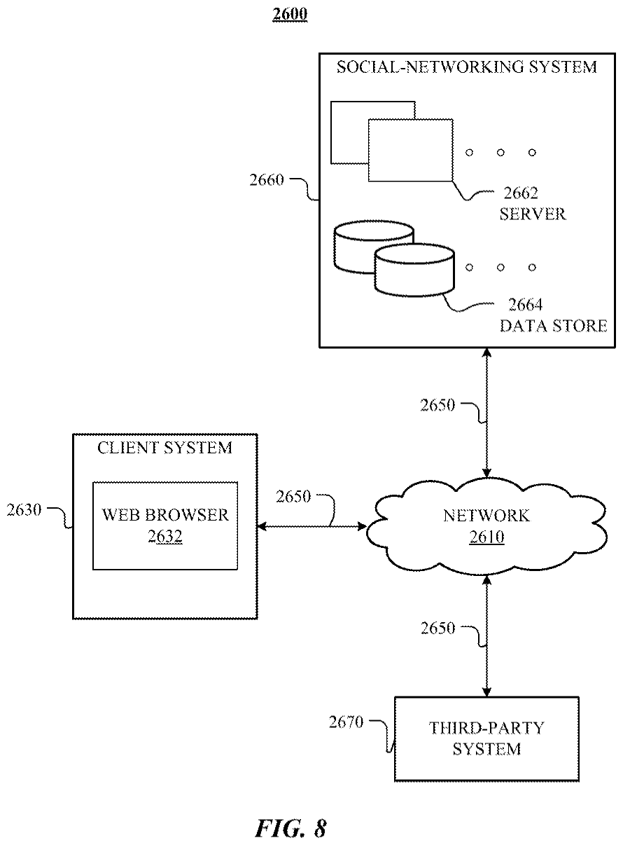

FIG. 8 illustrates an example network environment 2600 associated with a social-networking system. Network environment 2600 includes a client system 2630, a social-networking system 2660, and a third-party system 2670 connected to each other by a network 2610. Although FIG. 8 illustrates a particular arrangement of client system 2630, social-networking system 2660, third-party system 2670, and network 2610, this disclosure contemplates any suitable arrangement of client system 2630, social-networking system 2660, third-party system 2670, and network 2610. As an example and not by way of limitation, two or more of client system 2630, social-networking system 2660, and third-party system 2670 may be connected to each other directly, bypassing network 2610. As another example, two or more of client system 2630, social-networking system 2660, and third-party system 2670 may be physically or logically co-located with each other in whole or in part. Moreover, although FIG. 8 illustrates a particular number of client systems 2630, social-networking systems 2660, third-party systems 2670, and networks 2610, this disclosure contemplates any suitable number of client systems 2630, social-networking systems 2660, third-party systems 2670, and networks 2610. As an example and not by way of limitation, network environment 2600 may include multiple client system 2630, social-networking systems 2660, third-party systems 2670, and networks 2610.

This disclosure contemplates any suitable network 2610. As an example and not by way of limitation, one or more portions of network 2610 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 2610 may include one or more networks 2610.

Links 2650 may connect client system 2630, social-networking system 2660, and third-party system 2670 to communication network 2610 or to each other. This disclosure contemplates any suitable links 2650. In particular embodiments, one or more links 2650 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 2650 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 2650, or a combination of two or more such links 2650. Links 2650 need not necessarily be the same throughout network environment 2600. One or more first links 2650 may differ in one or more respects from one or more second links 2650.

In particular embodiments, client system 2630 may be an electronic device including hardware, software, or embedded logic components or a combination of two or more such components and capable of carrying out the appropriate functionalities implemented or supported by client system 2630. As an example and not by way of limitation, a client system 2630 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 2630. A client system 2630 may enable a network user at client system 2630 to access network 2610. A client system 2630 may enable its user to communicate with other users at other client systems 2630.

In particular embodiments, client system 2630 may include a web browser 2632, and may have one or more add-ons, plug-ins, or other extensions. A user at client system 2630 may enter a Uniform Resource Locator (URL) or other address directing the web browser 2632 to a particular server (such as server 2662, or a server associated with a third-party system 2670), and the web browser 2632 may generate a Hyper Text Transfer Protocol (HTTP) request and communicate the HTTP request to server. The server may accept the HTTP request and communicate to client system 2630 one or more Hyper Text Markup Language (HTML) files responsive to the HTTP request. Client system 2630 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts, combinations of markup language and scripts, and the like. Herein, reference to a webpage encompasses one or more corresponding webpage files (which a browser may use to render the webpage) and vice versa, where appropriate.

In particular embodiments, social-networking system 2660 may be a network-addressable computing system that can host an online social network. Social-networking system 2660 may generate, store, receive, and send social-networking data, such as, for example, user-profile data, concept-profile data, social-graph information, or other suitable data related to the online social network. Social-networking system 2660 may be accessed by the other components of network environment 2600 either directly or via network 2610. As an example and not by way of limitation, client system 2630 may access social-networking system 2660 using a web browser 2632, or a native application associated with social-networking system 2660 (e.g., a mobile social-networking application, a messaging application, another suitable application, or any combination thereof) either directly or via network 2610. In particular embodiments, social-networking system 2660 may include one or more servers 2662. Each server 2662 may be a unitary server or a distributed server spanning multiple computers or multiple datacenters. Servers 2662 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 2662 may include hardware, software, or embedded logic components or a combination of two or more such components for carrying out the appropriate functionalities implemented or supported by server 2662. In particular embodiments, social-networking system 2660 may include one or more data stores 2664. Data stores 2664 may be used to store various types of information. In particular embodiments, the information stored in data stores 2664 may be organized according to specific data structures. In particular embodiments, each data store 2664 may be a relational, columnar, correlation, or other suitable database. Although this disclosure describes or illustrates particular types of databases, this disclosure contemplates any suitable types of databases. Particular embodiments may provide interfaces that enable a client system 2630, a social-networking system 2660, or a third-party system 2670 to manage, retrieve, modify, add, or delete, the information stored in data store 2664.

In particular embodiments, social-networking system 2660 may store one or more social graphs in one or more data stores 2664. In particular embodiments, a social graph may include multiple nodes—which may include multiple user nodes (each corresponding to a particular user) or multiple concept nodes (each corresponding to a particular concept)—and multiple edges connecting the nodes. Social-networking system 2660 may provide users of the online social network the ability to communicate and interact with other users. In particular embodiments, users may join the online social network via social-networking system 2660 and then add connections (e.g., relationships) to a number of other users of social-networking system 2660 to whom they want to be connected. Herein, the term “friend” may refer to any other user of social-networking system 2660 with whom a user has formed a connection, association, or relationship via social-networking system 2660.

In particular embodiments, social-networking system 2660 may provide users with the ability to take actions on various types of items or objects, supported by social-networking system 2660. As an example and not by way of limitation, the items and objects may include groups or social networks to which users of social-networking system 2660 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 2660 or by an external system of third-party system 2670, which is separate from social-networking system 2660 and coupled to social-networking system 2660 via a network 2610.

In particular embodiments, social-networking system 2660 may be capable of linking a variety of entities. As an example and not by way of limitation, social-networking system 2660 may enable users to interact with each other as well as receive content from third-party systems 2670 or other entities, or to allow users to interact with these entities through an application programming interfaces (API) or other communication channels.

In particular embodiments, a third-party system 2670 may include one or more types of servers, one or more data stores, one or more interfaces, including but not limited to APIs, one or more web services, one or more content sources, one or more networks, or any other suitable components, e.g., that servers may communicate with. A third-party system 2670 may be operated by a different entity from an entity operating social-networking system 2660. In particular embodiments, however, social-networking system 2660 and third-party systems 2670 may operate in conjunction with each other to provide social-networking services to users of social-networking system 2660 or third-party systems 2670. In this sense, social-networking system 2660 may provide a platform, or backbone, which other systems, such as third-party systems 2670, may use to provide social-networking services and functionality to users across the Internet.

In particular embodiments, a third-party system 2670 may include a third-party content object provider. A third-party content object provider may include one or more sources of content objects, which may be communicated to a client system 2630. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 2660 also includes user-generated content objects, which may enhance a user's interactions with social-networking system 2660. User-generated content may include anything a user can add, upload, send, or “post” to social-networking system 2660. As an example and not by way of limitation, a user communicates posts to social-networking system 2660 from a client system 2630. Posts may include data such as status updates or other textual data, location information, photos, videos, links, music or other similar data or media. Content may also be added to social-networking system 2660 by a third-party through a “communication channel,” such as a newsfeed or stream.

In particular embodiments, social-networking system 2660 may include a variety of servers, sub-systems, programs, modules, logs, and data stores. In particular embodiments, social-networking system 2660 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 2660 may also include suitable components such as network interfaces, security mechanisms, load balancers, failover servers, management-and-network-operations consoles, other suitable components, or any suitable combination thereof In particular embodiments, social-networking system 2660 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 2660 to one or more client systems 2630 or one or more third-party system 2670 via network 2610. The web server may include a mail server or other messaging functionality for receiving and routing messages between social-networking system 2660 and one or more client systems 2630. An API-request server may allow a third-party system 2670 to access information from social-networking system 2660 by calling one or more APIs. An action logger may be used to receive communications from a web server about a user's actions on or off social-networking system 2660. In conjunction with the action log, a third-party-content-object log may be maintained of user exposures to third-party-content objects. A notification controller may provide information regarding content objects to a client system 2630. Information may be pushed to a client system 2630 as notifications, or information may be pulled from client system 2630 responsive to a request received from client system 2630. Authorization servers may be used to enforce one or more privacy settings of the users of social-networking system 2660. A privacy setting of a user determines how particular information associated with a user can be shared. The authorization server may allow users to opt in to or opt out of having their actions logged by social-networking system 2660 or shared with other systems (e.g., third-party system 2670), such as, for example, by setting appropriate privacy settings. Third-party-content-object stores may be used to store content objects received from third parties, such as a third-party system 2670. Location stores may be used for storing location information received from client systems 2630 associated with users. Advertisement-pricing modules may combine social information, the current time, location information, or other suitable information to provide relevant advertisements, in the form of notifications, to a user.

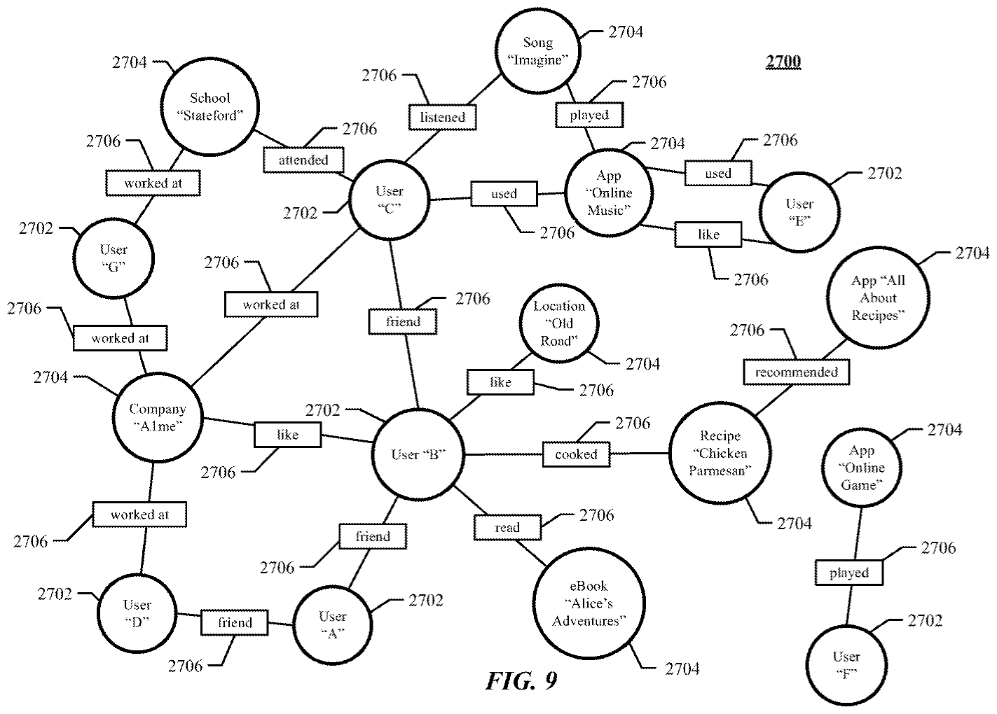

FIG. 9 illustrates example social graph 2700. In particular embodiments, social-networking system 2660 may store one or more social graphs 2700 in one or more data stores. In particular embodiments, social graph 2700 may include multiple nodes—which may include multiple user nodes 2702 or multiple concept nodes 2704—and multiple edges 2706 connecting the nodes. Each node may be associated with a unique entity (i.e., user or concept), each of which may have a unique identifier (ID), such as a unique number or username. Example social graph 2700 illustrated in FIG. 9 is shown, for didactic purposes, in a two-dimensional visual map representation. In particular embodiments, a social-networking system 2660, client system 2630, or third-party system 2670 may access social graph 2700 and related social-graph information for suitable applications. The nodes and edges of social graph 2700 may be stored as data objects, for example, in a data store (such as a social-graph database). Such a data store may include one or more searchable or queryable indexes of nodes or edges of social graph 2700.

In particular embodiments, a user node 2702 may correspond to a user of social-networking system 2660. As an example and not by way of limitation, a user may be an individual (human user), an entity (e.g., an enterprise, business, or third-party application), or a group (e.g., of individuals or entities) that interacts or communicates with or over social-networking system 2660. In particular embodiments, when a user registers for an account with social-networking system 2660, social-networking system 2660 may create a user node 2702 corresponding to the user, and store the user node 2702 in one or more data stores. Users and user nodes 2702 described herein may, where appropriate, refer to registered users and user nodes 2702 associated with registered users. In addition or as an alternative, users and user nodes 2702 described herein may, where appropriate, refer to users that have not registered with social-networking system 2660. In particular embodiments, a user node 2702 may be associated with information provided by a user or information gathered by various systems, including social-networking system 2660. As an example and not by way of limitation, a user may provide his or her name, profile picture, contact information, birth date, sex, marital status, family status, employment, education background, preferences, interests, or other demographic information. In particular embodiments, a user node 2702 may be associated with one or more data objects corresponding to information associated with a user. In particular embodiments, a user node 2702 may correspond to one or more webpages.

In particular embodiments, a concept node 2704 may correspond to a concept. As an example and not by way of limitation, a concept may correspond to a place (such as, for example, a movie theater, restaurant, landmark, or city); a website (such as, for example, a website associated with social-network system 2660 or a third-party website associated with a web-application server); an entity (such as, for example, a person, business, group, sports team, or celebrity); a resource (such as, for example, an audio file, video file, digital photo, text file, structured document, or application) which may be located within social-networking system 2660 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 2704 may be associated with information of a concept provided by a user or information gathered by various systems, including social-networking system 2660. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 2704 may be associated with one or more data objects corresponding to information associated with concept node 2704. In particular embodiments, a concept node 2704 may correspond to one or more webpages.

In particular embodiments, a node in social graph 2700 may represent or be represented by a webpage (which may be referred to as a “profile page”). Profile pages may be hosted by or accessible to social-networking system 2660. Profile pages may also be hosted on third-party websites associated with a third-party system 2670. As an example and not by way of limitation, a profile page corresponding to a particular external webpage may be the particular external webpage and the profile page may correspond to a particular concept node 2704. Profile pages may be viewable by all or a selected subset of other users. As an example and not by way of limitation, a user node 2702 may have a corresponding user-profile page in which the corresponding user may add content, make declarations, or otherwise express himself or herself. As another example and not by way of limitation, a concept node 2704 may have a corresponding concept-profile page in which one or more users may add content, make declarations, or express themselves, particularly in relation to the concept corresponding to concept node 2704.

In particular embodiments, a concept node 2704 may represent a third-party webpage or resource hosted by a third-party system 2670. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 2630 to send to social-networking system 2660 a message indicating the user's action. In response to the message, social-networking system 2660 may create an edge (e.g., a check-in-type edge) between a user node 2702 corresponding to the user and a concept node 2704 corresponding to the third-party webpage or resource and store edge 2706 in one or more data stores.

In particular embodiments, a pair of nodes in social graph 2700 may be connected to each other by one or more edges 2706. An edge 2706 connecting a pair of nodes may represent a relationship between the pair of nodes. In particular embodiments, an edge 2706 may include or represent one or more data objects or attributes corresponding to the relationship between a pair of nodes. As an example and not by way of limitation, a first user may indicate that a second user is a “friend” of the first user. In response to this indication, social-networking system 2660 may send a “friend request” to the second user. If the second user confirms the “friend request,” social-networking system 2660 may create an edge 2706 connecting the first user' s user node 2702 to the second user's user node 2702 in social graph 2700 and store edge 2706 as social-graph information in one or more of data stores 2664. In the example of FIG. 9, social graph 2700 includes an edge 2706 indicating a friend relation between user nodes 2702 of user “A” and user “B” and an edge indicating a friend relation between user nodes 2702 of user “C” and user “B.” Although this disclosure describes or illustrates particular edges 2706 with particular attributes connecting particular user nodes 2702, this disclosure contemplates any suitable edges 2706 with any suitable attributes connecting user nodes 2702. As an example and not by way of limitation, an edge 2706 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 2700 by one or more edges 2706. The degree of separation between two objects represented by two nodes, respectively, is a count of edges in a shortest path connecting the two nodes in the social graph 2700. As an example and not by way of limitation, in the social graph 2700, the user node 2702 of user “C” is connected to the user node 2702 of user “A” via multiple paths including, for example, a first path directly passing through the user node 2702 of user “B,” a second path passing through the concept node 2704 of company “Alme” and the user node 2702 of user “D,” and a third path passing through the user nodes 2702 and concept nodes 2704 representing school “Stateford,” user “G,” company “Alme,” and user “D.” User “C” and user “A” have a degree of separation of two because the shortest path connecting their corresponding nodes (i.e., the first path) includes two edges 2706.

In particular embodiments, an edge 2706 between a user node 2702 and a concept node 2704 may represent a particular action or activity performed by a user associated with user node 2702 toward a concept associated with a concept node 2704. As an example and not by way of limitation, as illustrated in FIG. 9, a user may “like,” “attended,” “played,” “listened,” “cooked,” “worked at,” or “watched” a concept, each of which may correspond to an edge type or subtype. A concept-profile page corresponding to a concept node 2704 may include, for example, a selectable “check in” icon (such as, for example, a clickable “check in” icon) or a selectable “add to favorites” icon. Similarly, after a user clicks these icons, social-networking system 2660 may create a “favorite” edge or a “check in” edge in response to a user's action corresponding to a respective action. As another example and not by way of limitation, a user (user “C”) may listen to a particular song (“Imagine”) using a particular application (a third-party online music application). In this case, social-networking system 2660 may create a “listened” edge 2706 and a “used” edge (as illustrated in FIG. 9) between user nodes 2702 corresponding to the user and concept nodes 2704 corresponding to the song and application to indicate that the user listened to the song and used the application. Moreover, social-networking system 2660 may create a “played” edge 2706 (as illustrated in FIG. 9) between concept nodes 2704 corresponding to the song and the application to indicate that the particular song was played by the particular application. In this case, “played” edge 2706 corresponds to an action performed by an external application (the third-party online music application) on an external audio file (the song “Imagine”). Although this disclosure describes particular edges 2706 with particular attributes connecting user nodes 2702 and concept nodes 2704, this disclosure contemplates any suitable edges 2706 with any suitable attributes connecting user nodes 2702 and concept nodes 2704. Moreover, although this disclosure describes edges between a user node 2702 and a concept node 2704 representing a single relationship, this disclosure contemplates edges between a user node 2702 and a concept node 2704 representing one or more relationships. As an example and not by way of limitation, an edge 2706 may represent both that a user likes and has used at a particular concept. Alternatively, another edge 2706 may represent each type of relationship (or multiples of a single relationship) between a user node 2702 and a concept node 2704 (as illustrated in FIG. 9 between user node 2702 for user “E” and concept node 2704 for “online music application”).

In particular embodiments, social-networking system 2660 may create an edge 2706 between a user node 2702 and a concept node 2704 in social graph 2700. As an example and not by way of limitation, a user viewing a concept-profile page (such as, for example, by using a web browser or a special-purpose application hosted by the user's client system 2630) may indicate that he or she likes the concept represented by the concept node 2704 by clicking or selecting a “Like” icon, which may cause the user's client system 2630 to send to social-networking system 2660 a message indicating the user's liking of the concept associated with the concept-profile page. In response to the message, social-networking system 2660 may create an edge 2706 between user node 2702 associated with the user and concept node 2704, as illustrated by “like” edge 2706 between the user and concept node 2704. In particular embodiments, social-networking system 2660 may store an edge 2706 in one or more data stores. In particular embodiments, an edge 2706 may be automatically formed by social-networking system 2660 in response to a particular user action. As an example and not by way of limitation, if a first user uploads a picture, watches a movie, or listens to a song, an edge 2706 may be formed between user node 2702 corresponding to the first user and concept nodes 2704 corresponding to those concepts. Although this disclosure describes forming particular edges 2706 in particular manners, this disclosure contemplates forming any suitable edges 2706 in any suitable manner.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page that identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 2704 corresponding to a particular photo may have a privacy setting specifying that the photo may only be accessed by users tagged in the photo and their friends. In particular embodiments, privacy settings may allow users to opt in or opt out of having their actions logged by social-networking system 2660 or shared with other systems (e.g., third-party system 2670). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 2670, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers 2662 may be authorization/privacy servers for enforcing privacy settings. In response to a request from a user (or other entity) for a particular object stored in a data store 2664, social-networking system 2660 may send a request to the data store 2664 for the object. The request may identify the user associated with the request and may only be sent to the user (or a client system 2630 of the user) if the authorization server determines that the user is authorized to access the object based on the privacy settings associated with the object. If the requesting user is not authorized to access the object, the authorization server may prevent the requested object from being retrieved from the data store 2664, or may prevent the requested object from being sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

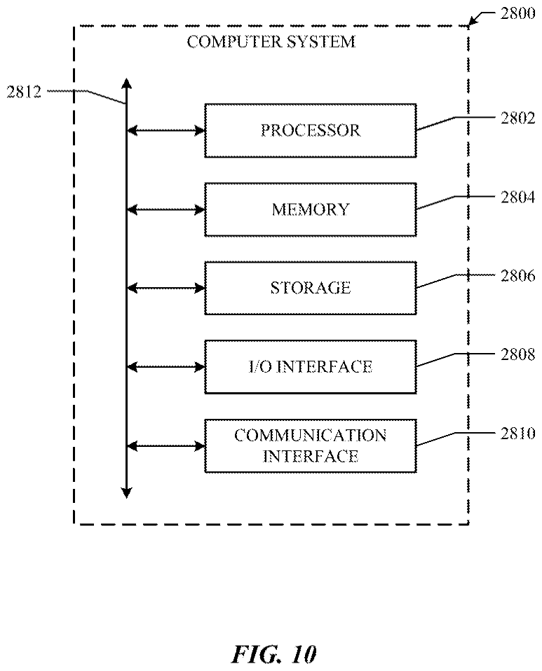

FIG. 10 illustrates an example computer system 2800. In particular embodiments, one or more computer systems 2800 perform one or more steps of one or more methods described or illustrated herein. In particular embodiments, one or more computer systems 2800 provide functionality described or illustrated herein. In particular embodiments, software running on one or more computer systems 2800 performs one or more steps of one or more methods described or illustrated herein or provides functionality described or illustrated herein. Particular embodiments include one or more portions of one or more computer systems 2800. Herein, reference to a computer system may encompass a computing device, and vice versa, where appropriate. Moreover, reference to a computer system may encompass one or more computer systems, where appropriate.

This disclosure contemplates any suitable number of computer systems 2800. This disclosure contemplates computer system 2800 taking any suitable physical form. As example and not by way of limitation, computer system 2800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, a Cloud virtual machine/container, or a combination of two or more of these. Where appropriate, computer system 2800 may include one or more computer systems 2800; be unitary or distributed; span multiple locations; span multiple machines; span multiple data centers; or reside in a cloud, which may include one or more cloud components in one or more networks. Where appropriate, one or more computer systems 2800 may perform without substantial spatial or temporal limitation one or more steps of one or more methods described or illustrated herein. As an example and not by way of limitation, one or more computer systems 2800 may perform in real time or in batch mode one or more steps of one or more methods described or illustrated herein. One or more computer systems 2800 may perform at different times or at different locations one or more steps of one or more methods described or illustrated herein, where appropriate.

In particular embodiments, computer system 2800 includes a processor 2802, memory 2804, storage 2806, an input/output (I/O) interface 2808, a communication interface 2810, and a bus 2812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 2802 includes hardware for executing instructions, such as those making up a computer program. As an example and not by way of limitation, to execute instructions, processor 2802 may retrieve (or fetch) the instructions from an internal register, an internal cache, memory 2804, or storage 2806; decode and execute them; and then write one or more results to an internal register, an internal cache, memory 2804, or storage 2806. In particular embodiments, processor 2802 may include one or more internal caches for data, instructions, or addresses. This disclosure contemplates processor 2802 including any suitable number of any suitable internal caches, where appropriate. As an example and not by way of limitation, processor 2802 may include one or more instruction caches, one or more data caches, and one or more translation lookaside buffers (TLBs). Instructions in the instruction caches may be copies of instructions in memory 2804 or storage 2806, and the instruction caches may speed up retrieval of those instructions by processor 2802. Data in the data caches may be copies of data in memory 2804 or storage 2806 for instructions executing at processor 2802 to operate on; the results of previous instructions executed at processor 2802 for access by subsequent instructions executing at processor 2802 or for writing to memory 2804 or storage 2806; or other suitable data. The data caches may speed up read or write operations by processor 2802. The TLBs may speed up virtual-address translation for processor 2802. In particular embodiments, processor 2802 may include one or more internal registers for data, instructions, or addresses. This disclosure contemplates processor 2802 including any suitable number of any suitable internal registers, where appropriate. Where appropriate, processor 2802 may include one or more arithmetic logic units (ALUs); be a multi-core processor; or include one or more processors 2802. Although this disclosure describes and illustrates a particular processor, this disclosure contemplates any suitable processor.

In particular embodiments, memory 2804 includes main memory for storing instructions for processor 2802 to execute or data for processor 2802 to operate on. As an example and not by way of limitation, computer system 2800 may load instructions from storage 2806 or another source (such as, for example, another computer system 2800) to memory 2804. Processor 2802 may then load the instructions from memory 2804 to an internal register or internal cache. To execute the instructions, processor 2802 may retrieve the instructions from the internal register or internal cache and decode them. During or after execution of the instructions, processor 2802 may write one or more results (which may be intermediate or final results) to the internal register or internal cache. Processor 2802 may then write one or more of those results to memory 2804. In particular embodiments, processor 2802 executes only instructions in one or more internal registers or internal caches or in memory 2804 (as opposed to storage 2806 or elsewhere) and operates only on data in one or more internal registers or internal caches or in memory 2804 (as opposed to storage 2806 or elsewhere). One or more memory buses (which may each include an address bus and a data bus) may couple processor 2802 to memory 2804. Bus 2812 may include one or more memory buses, as described below. In particular embodiments, one or more memory management units (MMUs) reside between processor 2802 and memory 2804 and facilitate accesses to memory 2804 requested by processor 2802. In particular embodiments, memory 2804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 2804 may include one or more memories 2804, where appropriate. Although this disclosure describes and illustrates particular memory, this disclosure contemplates any suitable memory.

In particular embodiments, storage 2806 includes mass storage for data or instructions. As an example and not by way of limitation, storage 2806 may include a hard disk drive (HDD), a floppy disk drive, flash memory, an optical disc, a magneto-optical disc, magnetic tape, or a Universal Serial Bus (USB) drive or a combination of two or more of these. Storage 2806 may include removable or non-removable (or fixed) media, where appropriate. Storage 2806 may be internal or external to computer system 2800, where appropriate. In particular embodiments, storage 2806 is non-volatile, solid-state memory. In particular embodiments, storage 2806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 2806 taking any suitable physical form. Storage 2806 may include one or more storage control units facilitating communication between processor 2802 and storage 2806, where appropriate. Where appropriate, storage 2806 may include one or more storages 2806. Although this disclosure describes and illustrates particular storage, this disclosure contemplates any suitable storage.

In particular embodiments, I/O interface 2808 includes hardware, software, or both, providing one or more interfaces for communication between computer system 2800 and one or more I/O devices. Computer system 2800 may include one or more of these I/O devices, where appropriate. One or more of these I/O devices may enable communication between a person and computer system 2800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 2808 for them. Where appropriate, I/O interface 2808 may include one or more device or software drivers enabling processor 2802 to drive one or more of these I/O devices. I/O interface 2808 may include one or more I/O interfaces 2808, where appropriate. Although this disclosure describes and illustrates a particular I/O interface, this disclosure contemplates any suitable I/O interface.

In particular embodiments, communication interface 2810 includes hardware, software, or both providing one or more interfaces for communication (such as, for example, packet-based communication) between computer system 2800 and one or more other computer systems 2800 or one or more networks. As an example and not by way of limitation, communication interface 2810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 2810 for it. As an example and not by way of limitation, computer system 2800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 2800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 2800 may include any suitable communication interface 2810 for any of these networks, where appropriate. Communication interface 2810 may include one or more communication interfaces 2810, where appropriate. Although this disclosure describes and illustrates a particular communication interface, this disclosure contemplates any suitable communication interface.

In particular embodiments, bus 2812 includes hardware, software, or both coupling components of computer system 2800 to each other. As an example and not by way of limitation, bus 2812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 2812 may include one or more buses 2812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing device:
accessing a definition of a machine-learning model and its corresponding training configurations;
adjusting the definition of the machine-learning model to downscale the machine-learning model;
modifying one or more of the corresponding training configurations to reduce complexity of training the machine-learning model;
performing a downscaled training of the machine-learning model of the adjusted definition using the modified corresponding training configurations;
determining that one or more errors caused by either the non-adjusted definition of the machine-learning model or non-modified corresponding training configurations occur based on a return code of the downscaled training; and
causing, in response to the determination, a training of the machine-learning model of non-adjusted definition using the non-modified corresponding training configurations to be aborted.

2. A method comprising, by a computing system:
determining a first set of bins that collectively cover a pre-determined numerical range with each bin covering a sub-range of the pre-determined range;
determining a second set of bins that collectively cover the pre-determined range, wherein each of the second set of bins covers a different but overlapping sub-range with respect to a corresponding bin in the first bin set;
accessing a value that falls within the pre-determined range;
determining that the value falls within a first bin of the first bin set and a second bin of the second bin set;
determining a positive value for each the first and second bins, wherein the positive values indicates an association level of the value with the first and second bins; and
determining a representation of the value based on a weighted average of associated vectors determined based on the positive values.
